(19) United States
(12) Patent Application Publication
(10) Pub. No.: US 2009/0305143 A1
(43) Pub. Date: Dec. 10, 2009

(54) NON-AQUEOUS ELECTROLYTE SECONDARY BATTERY

(76) Inventors: Hiroshi Matsuno, Osaka (JP); Takaharu Morikawa, Osaka (JP); Akihiro Maeda, Osaka (JP); Takeshi Yao, Hyogo (JP)

Correspondence Address: MCDERMOTT WILL & EMERY LLP, 600 13TH STREET, NW, WASHINGTON, DC, 20005-3096, US

(21) Appl. No.: 12/067,923

(22) PCT Filed: May 9, 2007
(86) PCT No.: PCT/JP2007/059593

§ 371 Date: Mar. 24, 2008

(51) Int. Cl. H01M 10/26; H01M 6/16; H01M 10/40

(52) U.S. Cl. 429/332; 429/207; 429/200

(57) ABSTRACT

This invention relates to a non-aqueous electrolyte secondary battery including a positive electrode including a positive electrode mixture, a negative electrode, a separator, and a non-aqueous electrolyte. The positive electrode mixture includes a positive electrode active material, and the positive electrode active material includes a lithium nickel composite oxide. The non-aqueous electrolyte includes a non-aqueous solvent and a lithium salt dissolved in the non-aqueous solvent. The amount of moisture contained in the positive electrode mixture is greater than 1000 ppm and equal to or less than 6000 ppm. By adjusting the amount of moisture contained in the positive electrode mixture in the above range, it is possible to improve the cycle characteristics of the non-aqueous electrolyte secondary battery including the lithium nickel composite oxide as the positive electrode active material.

### TECHNICAL FIELD

The present invention relates to non-aqueous electrolyte secondary batteries, and specifically, to a non-aqueous electrolyte secondary battery whose cycle life characteristics are improved by controlling the amount of moisture contained in the positive electrode mixture.

### BACKGROUND ART

Recently, there has been a remarkable trend for portable electronic appliances to become smaller, thinner, lighter, and higher in functionality. Batteries used as power sources therefor are accordingly required to become smaller, thinner, and lighter and have higher capacity and longer life. Non-aqueous electrolyte secondary batteries are preferable as small, thin, light, and high-capacity batteries. Among them, lithium secondary batteries are most preferable. Since currently available lithium secondary batteries can be repeatedly charged/discharged, they are increasingly used as the power source for portable electronic appliances such as cellular phones and notebook personal computers.

Positive electrode active materials used in such lithium secondary batteries are lithium-containing transition metal oxides such as lithium cobaltate (LiCoO₂) and lithium nickelate (LiNiO₂). Such lithium-containing transition metal oxides have high capacity densities and exhibit good reversibility in a high voltage range.

The positive electrode active material LiNiO₂ has a higher capacity than LiCoO₂, and is thus expected as an inexpensive, high energy-density material. However, batteries including LiNiO₂ as a positive electrode active material have a short cycle life. To solve this problem, it is proposed to subject the positive electrode active material to a water washing treatment, or use a predetermined non-aqueous electrolyte (e.g., see Patent Documents 1 and 2).

### Patent Document 1: Japanese Laid-Open Patent Publication No. 2003-17054

Patent Document 2: Japanese Laid-Open Patent Publication No. Hei 9-231973

### DISCLOSURE OF THE INVENTION

### Problem to be Solved by the Invention

However, the recent trend for higher capacity has resulted in an increase in negative electrode density. Hence, upon repeated charged/discharge, the negative electrode undergoes a large polarization, so that the ion acceptance of the negative electrode lowers. This causes deposition of lithium metal, thereby leading to expansion of the electrode plate and evolution of gas. Consequently, the deposition of lithium metal is further accelerated, thereby resulting in degradation of cycle characteristics.

Meanwhile, the use of a lithium nickel composite oxide (e.g., LiNiO₂) as a positive electrode active material results in higher capacity, less expansion of the positive electrode plate even upon repeated charge/discharge, and less polarization than the use of a lithium cobalt composite oxide (e.g., LiCoO₂). Hence, upon repeated charge/discharge, the negative electrode deteriorates before the positive electrode does.

As described above, the use of a lithium nickel composite oxide as a positive electrode active material involves significant deterioration of the negative electrode although the deterioration of the positive electrode is small. The imbalance between the deterioration of the positive electrode and the deterioration of the negative electrode lowers cycle characteristics.

It is therefore an object of the present invention to solve the above-described problems and provide a non-aqueous electrolyte secondary battery having a high capacity and good cycle characteristics.

### Means for Solving the Problem

The non-aqueous electrolyte secondary battery of the present invention includes a positive electrode including a positive electrode mixture, a negative electrode, a separator, and a non-aqueous electrolyte. The positive electrode mixture includes a positive electrode active material, and the positive electrode active material includes a lithium nickel composite oxide. The non-aqueous electrolyte includes a non-aqueous solvent and a lithium salt dissolved in the non-aqueous solvent. The amount of moisture contained in the positive electrode mixture is greater than 1000 ppm and equal to or less than 6000 ppm.

The non-aqueous solvent preferably includes a cyclic carbonate and a chain carbonate.

The lithium nickel composite oxide is preferably represented by the following general formula (1):

LiₓNi_{y}M_{1-y}O₂ (1)

where M is at least one element selected from the group consisting of Co, Mn, Cr, Fe, Mg, Ti, and Al, 0.95≦x≦1.10, and 0.3≦y≦1.0.

The cyclic carbonate preferably includes at least one selected from the group consisting of ethylene carbonate, propylene carbonate, and butylene carbonate.

The chain carbonate preferably includes at least one selected from the group consisting of dimethyl carbonate, diethyl carbonate, ethyl methyl carbonate, di-n-propyl carbonate, methyl-n-propyl carbonate, ethyl-n-propyl carbonate, methyl-i-propyl(isopropyl)carbonate, and ethyl-i-propyl carbonate. Also, more preferably, the chain carbonate is diethyl carbonate alone or includes diethyl carbonate and ethyl methyl carbonate. When the chain carbonate includes diethyl carbonate and ethyl methyl carbonate, the volume ratio of diethyl carbonate to ethyl methyl carbonate is preferably from 1:3 to 3:1.

Preferably, the non-aqueous electrolyte further includes an organic substance including at least one selected from the group consisting of a benzene ring and a cyclohexane ring, and the amount of the organic substance is 0.3 to 1.2 parts by weight per 100 parts by weight of the non-aqueous electrolyte. More preferably, the organic substance includes at least one selected from the group consisting of biphenyl, cyclohexyl benzene, diphenyl ether, o-terphenyl, p-terphenyl, and fluoroanisole.

The positive electrode mixture preferably has a porosity of 12 to 21% by volume.

Preferably, the positive electrode mixture includes a conductive agent, and the amount of the conductive agent contained in the positive electrode mixture is 1.2 to 6.0 parts by weight per 100 parts by weight of the positive electrode active material. More preferably, the conductive agent includes at least one selected from the group consisting of graphite and carbon black.

### EFFECTS OF THE INVENTION

In the present invention, the amount of moisture contained in the positive electrode mixture is greater than 1000 ppm and equal to or less than 6000 ppm. This can increase the polarization of the positive electrode including the lithium nickel composite oxide as the positive electrode active material. It is therefore possible to improve the balance between the polarization of the positive electrode and the polarization of the negative electrode after repetitive charge/discharge. As a result, the cycle characteristics can be improved.

### BRIEF DESCRIPTION OF DRAWINGS

FIG. 1 is a perspective view of a non-aqueous electrolyte secondary battery prepared in an Example;

FIG. 2 is a schematic view showing a longitudinal section of the battery of FIG. 1 taken along the A-A line; and

FIG. 3 is a schematic view showing a longitudinal section of the battery of FIG. 1 taken along the B-B line.

### BEST MODE FOR CARRYING OUT THE INVENTION

The non-aqueous electrolyte secondary battery of the present invention includes a positive electrode, a negative electrode, a separator disposed between the positive electrode and the negative electrode, and a non-aqueous electrolyte. The positive electrode includes a positive electrode mixture, and the positive electrode mixture includes a lithium nickel composite oxide as a positive electrode active material. The non-aqueous electrolyte includes a non-aqueous solvent and a lithium salt dissolved in the non-aqueous solvent.

The amount of moisture contained in the positive electrode mixture is greater than 1000 ppm and equal to or less than 6000 ppm.

When the amount of moisture in the positive electrode mixture is equal to or less than 1000 ppm, the degree of polarization of the positive electrode is smaller than the degree of polarization of the negative electrode upon repeated charge/discharge cycles, thereby resulting in degradation of cycle characteristics. When the amount of moisture in the positive electrode mixture is greater than 6000 ppm, a lithium compound (e.g., lithium carbonate, lithium hydroxide, etc.) remaining in the positive electrode excessively adsorbs carbon dioxide in an environment to which the positive electrode is exposed. Hence, when charge/discharge is repeated in a high-temperature environment, carbon dioxide is generated, thereby causing the battery to swell.

In particular, the amount of moisture contained in the positive electrode mixture is preferably 2000 to 5000 ppm. When the amount of moisture is less than 2000 ppm, productivity may lower or managing costs (e.g., costs necessary for controlling dew point by means of dry air or dry nitrogen so as to prevent adsorption of carbon dioxide) may be necessary. When the amount of moisture is greater than 5000 ppm, carbon dioxide may be generated upon storage in a high-temperature environment at 45° C. or higher, thereby causing the battery to swell.

The amount of moisture contained in the positive electrode mixture can be adjusted, for example, by adding moisture to the positive electrode mixture. Methods of adding moisture to the positive electrode mixture include, for example, the following two methods. The first method is a method of directly adding moisture to the positive electrode mixture. The second method is a method of indirectly adding moisture to the positive electrode mixture.

Examples of the first method include a method of immersing the positive electrode in water (preferably pure water or ion-exchange water) for a predetermined time, a method of immersing the positive electrode in water for a predetermined time and then drying it for a predetermined time, and a method of leaving the positive electrode in an atmosphere with a predetermined dew point for a predetermined time.

An example of the second method is a method of adding moisture to at least one constituent component (e.g., negative electrode, separator, non-aqueous electrolyte, etc.) of a non-aqueous electrolyte secondary excluding the positive electrode, and causing the moisture in the component excluding the positive electrode to move to the positive electrode by charging/discharging the produced non-aqueous electrolyte secondary battery or leaving it.

An example of methods of adding moisture to at least one component excluding the positive electrode is a method of adding a predetermined amount of moisture to the component excluding the positive electrode. Such methods include, for example, a method of directly adding moisture to the negative electrode and a method of directly adding moisture to the separator, in the same manner as the first method. Examples of methods of adding moisture to the non-aqueous electrolyte include a method of directly adding a predetermined amount of moisture to the non-aqueous electrolyte, and a method of leaving the non-aqueous electrolyte in an atmosphere with a predetermined dew point for a predetermined time.

In the case of adding moisture to at least one component excluding the positive electrode, moisture may be added to one component or two or more components.

In the case of causing moisture to be absorbed into the component excluding the positive electrode to move the moisture to the positive electrode, the adsorption of moisture onto the positive electrode reaches equilibrium in approximately 2 to 3 hours, although it depends on the amount of moisture.

In this way, by adding moisture to the positive electrode or causing moisture to be adsorbed onto the positive electrode, it is possible to increase polarization of the positive electrode in an initial stage and equalize the degree of polarization of the positive electrode and the degree of polarization of the negative electrode after repeated charge/discharge. It is therefore possible to improve the cycle characteristics of the non-aqueous electrolyte secondary battery.

The reason for improved cycle characteristics is probably as follows. When the increase in polarization of the positive electrode upon repeated charge/discharge is small, a difference occurs between the degree of deterioration of the positive electrode and the degree of deterioration of the negative electrode as charge/discharge progresses. That is, the negative electrode deteriorates in comparison with the positive electrode that is still active. Hence, the lithium ion acceptance of the negative electrode lowers, thereby causing deposition of lithium metal on the negative electrode or evolution of gas due to reaction between the deposited lithium metal and the non-aqueous electrolyte. As a result, the cycle characteristics degrade. It is presumed that increasing the initial polarization of the positive electrode allows suppression of the imbalance between the deterioration of the positive electrode and the deterioration of the negative electrode caused by charge/discharge cycles.

The non-aqueous solvent contained in the non-aqueous electrolyte preferably includes a chain carbonate and a cyclic carbonate. In this case, it is possible to obtain a non-aqueous electrolyte having a good balance between viscosity and ionic conductivity. When the non-aqueous solvent is composed only of a cyclic carbonate, the non-aqueous electrolyte has a high viscosity. When the non-aqueous solvent is composed only of a chain carbonate, the non-aqueous electrolyte has a low ionic conductivity.

The chain carbonate and the cyclic carbonate may be any compounds known in the art.

Among them, the cyclic carbonate preferably includes at least one selected from the group consisting of ethylene carbonate, propylene carbonate, and butylene carbonate. Further, the cyclic carbonate preferably includes not less than 50% by volume of ethylene carbonate.

When the cyclic carbonate includes such compound(s), the dielectric constant of the non-aqueous electrolyte can be heightened. Also, since a stable coating film is formed on the negative electrode surface, decomposition of the lithium salt in the non-aqueous electrolyte is suppressed upon repeated charge/discharge. It is thus possible to obtain a non-aqueous electrolyte secondary battery with improved cycle characteristics.

Further, when the cyclic carbonate includes not less than 50% by volume of ethylene carbonate, it is possible to reduce the ratio of propylene carbonate, butylene carbonate, etc., which are easily decomposed during charging/discharging. This allows a reduction in the amount of gas produced during charging/discharging. It is therefore possible to obtain a non-aqueous electrolyte secondary battery with further improved cycle characteristics.

The chain carbonate preferably includes at least one selected from the group consisting of dimethyl carbonate, diethyl carbonate, ethyl methyl carbonate, di-n-propyl carbonate, methyl-n-propyl carbonate, ethyl-n-propyl carbonate, methyl-i-propyl carbonate, and ethyl-i-propyl carbonate. Further, the chain carbonate preferably includes at least ethyl methyl carbonate. When the chain carbonate includes such compound(s), it is possible to obtain a non-aqueous electrolyte secondary battery having a good balance between reliability upon high-temperature storage, cycle characteristics, and safety.

In another embodiment of the present invention, it is preferable that the chain carbonate be diethyl carbonate alone or include diethyl carbonate and ethyl methyl carbonate. When the chain carbonate is diethyl carbonate or includes diethyl carbonate and ethyl methyl carbonate, it is possible to obtain a non-aqueous electrolyte secondary battery having a good balance between charge/discharge capacity, cycle characteristics, reliability upon high-temperature storage, and safety.

When the chain carbonate includes diethyl carbonate and ethyl methyl carbonate, the volume ratio of diethyl carbonate to ethyl methyl carbonate is preferably from 3:1 to 1:3. If the ratio of diethyl carbonate is less than 25% by volume, ethyl methyl carbonate that is easily decomposed during charging/discharging and during high-temperature storage constitutes a large ratio. Hence, upon repeated charge/discharge or high-temperature storage, the amount of gas produced in the battery may increase. If the ratio of diethyl carbonate is greater than 75% by volume, the non-aqueous electrolyte has a high viscosity, so that injection of such non-aqueous electrolyte into the non-aqueous electrolyte secondary battery may take a long time, thereby resulting in a decrease in productivity.

Cyclic carbonates, which are high dielectric-constant solvents, and chain carbonates, which are low viscosity solvents, may be freely selected for use in combination. In the non-aqueous solvent, for example, the volume ratio of a cyclic carbonate to a chain carbonate is preferably from 15:85 to 35:65.

The positive electrode may be composed only of a positive electrode mixture or may be composed of a positive electrode current collector and a positive electrode mixture layer carried thereon. The positive electrode mixture may contain a positive electrode active material, and if necessary, a binder, a conductive agent, etc.

The positive electrode active material preferably includes a lithium nickel composite oxide represented by the following general formula (1):

LiₓNi_{y}M_{1-y}O₂ (1)

where M is at least one selected from the group consisting of Co, Mn, Cr, Fe, Mg, Ti, and Al, 0.95≦x≦1.1, and 0.3≦y≦1. Such a material has a higher capacity than LiCoO₂, is available at lower costs, and offers a higher energy density.

If the molar ratio y of nickel is less than 0.3, it is difficult to obtain the merit of high capacity. If the molar ratio y of nickel is greater than 1, the resultant lithium nickel composite oxide may contain a by-product of a nickel oxide, thereby resulting in a decrease in the purity of the active material and the apparent energy density of the active material.

If the molar ratio x of lithium is less than 0.95, there are less lithium ions available, so that the capacity may decrease. If the molar ratio x of lithium is greater than 1.1, the resultant lithium nickel composite oxide may contain a by-product such as a lithium salt, thereby resulting in a decrease in the purity of the active material and the apparent energy density of the active material.

In the above general formula (1), the molar ratio x of lithium represents the amount of lithium contained in the positive electrode active material immediately after the preparation thereof. It should be noted that the value of the lithium molar ratio x changes upon charge/discharge.

The method for producing the positive electrode is not particularly limited. For example, a positive electrode active material, a solvent, and optionally, a binder, a thickener, a conductive agent, etc., are mixed together to form a positive electrode mixture slurry. The positive electrode mixture obtained is applied onto a current collector and dried to produce a positive electrode. The positive electrode obtained in the above manner may be formed into a sheet electrode by using rolls.

Alternatively, a positive electrode mixture containing a positive electrode active material and optionally a binder, etc. may be compression molded into a pellet electrode.

The material of the positive electrode current collector can be a metal such as aluminum (Al), titanium (Ti), or tantalum (Ta), or an alloy thereof. Among them, Al or an alloy thereof is desirably used since it is lightweight and advantageous in energy density.

Next, the method for measuring the amount of moisture contained in the positive electrode mixture is described.

A non-aqueous electrolyte secondary battery is disassembled and its positive electrode is collected. The collected positive electrode plate is immersed in a solution containing ethyl methyl carbonate at room temperature for 30 minutes. The immersed positive electrode plate is dried under a reduced pressure (10 Pa) at room temperature for 30 minutes, to volatilize the ethyl methyl carbonate.

Thereafter, the amount of moisture contained in the dried positive electrode mixture is measured. The amount of moisture can be measured, for example, by using a Karl Fischer moisture meter, and heating the dried positive electrode at 250° C. to a temperature lower than the baking temperature for the preparation of the positive electrode active material to evaporate the moisture. If the heating temperature of the positive electrode is lower than 250° C., it is only possible to measure the moisture adsorbed onto the positive electrode active material, conductive agent, etc. If the heating temperature of the positive electrode is equal to or higher than the baking temperature for the preparation of the positive electrode active material, the crystal structure of the positive electrode active material may be destroyed. The heating temperature of the positive electrode is preferably 250 to 350° C.

The non-aqueous electrolyte secondary battery before being disassembled may be in a charged state or a discharged state.

The non-aqueous electrolyte more preferably includes an organic substance including at least one selected from the group consisting of a benzene ring and a cyclohexane ring. The amount of the organic substance contained in the non-aqueous electrolyte is preferably 0.3 to 1.2 parts by weight per 100 parts by weight of the non-aqueous electrolyte.

The organic substance preferably includes at least one selected from the group consisting of biphenyl, cyclohexyl benzene, diphenyl ether, o-terphenyl, p-terphenyl, and fluoroanisole.

By using a non-aqueous electrolyte including such an organic substance, it is possible to further equalize the degree of polarization of the positive electrode and the degree of polarization of the negative electrode upon repeated charge/discharge. It is therefore possible to further improve the cycle characteristics of the non-aqueous electrolyte secondary battery.

If the amount of the organic substance is less than 0.3 part by weight per 100 parts by weight of the non-aqueous electrolyte, the effect of further increasing the polarization of the positive electrode may not be obtained. If the amount of the organic substance is greater than 1.2 parts by weight per 100 parts by weight of the non-aqueous electrolyte, the polarization of the positive electrode becomes greater at high temperatures, for example, upon charge/discharge cycles at 45° C. As a result, the degree of polarization of the positive electrode and the degree of polarization of the negative electrode become off balance, which may cause degradation of cycle characteristics.

The porosity of the positive electrode mixture contained in the positive electrode is preferably 12 to 21% by volume. By setting the porosity of the positive electrode mixture in the above range, it is possible to further equalize the degree of polarization of the positive electrode and the degree of polarization of the negative electrode upon repeated charge/discharge. It is therefore possible to further improve the cycle characteristics of the non-aqueous electrolyte secondary battery.

If the porosity of the positive electrode mixture is less than 12% by volume, the volume ratio of the non-aqueous electrolyte in the positive electrode mixture is low, so that the internal resistance during charging/discharging becomes high. As a result, the degree of polarization of the positive electrode becomes greater than the degree of polarization of the negative electrode, which may result in degradation of cycle characteristics.

If the porosity of the positive electrode mixture is higher than 21% by volume, the degree of activity of the positive electrode is enhanced, so that the degree of polarization of the positive electrode becomes less than the degree of polarization of the negative electrode. Thus, the cycle characteristics may lower.

The porosity of a positive electrode mixture is represented by [(Pore volume)/(Apparent volume of positive electrode mixture)]×100. Pore volume can be measured, for example, by a mercury injection method. Apparent volume of positive electrode mixture can be obtained, for example, from (Area of current collector where positive electrode mixture is carried)×(Height of positive electrode mixture). Height of positive electrode mixture can be measured, for example, by observation of a longitudinal section of a positive electrode mixture with an electron microscope.

The porosity of the positive electrode mixture can be adjusted, for example, by controlling the composition of the positive electrode mixture, the particle size of the positive electrode active material, the pressure applied for rolling, etc.

The negative electrode may be composed only of a negative electrode mixture or may include a negative electrode current collector and a negative electrode mixture layer carried thereon. The negative electrode mixture may contain a negative electrode active material, and if necessary, a binder, a conductive agent, etc.

The negative electrode active material preferably includes at least a graphite material. The physical properties of the graphite material are not particularly limited as long as it is capable of absorbing and desorbing lithium. Among them, preferred are artificial graphite prepared by subjecting graphitizable pitch obtained from various raw materials to high-temperature heat treatment, purified natural graphite, and materials obtained by subjecting these graphite materials to various surface treatments with pitch.

The negative electrode active material may further include a negative electrode material capable of absorbing and desorbing lithium other than the above-mentioned graphite materials. Exemplary negative electrode materials capable of absorbing and desorbing lithium other than the above-mentioned graphite materials are non-graphite carbon materials such as non-graphitizable carbon and carbon baked at low temperatures, metal oxide materials such as tin oxide and silicon oxide, lithium metal, and various lithium alloys. These materials may be used singly or in combination of two or more of them.

There is also no particular limitation with respect to the method for producing the negative electrode, and the negative electrode can be produced in a manner similar to the above-described production method of the positive electrode. Also, the shape of the negative electrode may be in the form of a sheet electrode or pellet electrode in the same manner as the positive electrode.

The material of the negative electrode current collector can be a metal such as copper (Cu), nickel (Ni), or stainless steel (SUS). Among them, Cu foil is preferably used as the negative electrode current collector since it is easily formed into a thin film and available at low costs.

The thickness of the positive electrode current collector and the negative electrode current collector can be, for example, 3 to 50 μm.

The binder for use in the positive electrode and the negative electrode is not particularly limited if it is a stable material with respect to the solvent and non-aqueous electrolyte used to prepare the electrodes. Specific examples of binders include polyvinylidene fluoride, polytetrafluoroethylene, styrene-butadiene rubber, isopropylene rubber, butadiene rubber, and ethylene propylene diethane polymer.

The thickener for use in the positive electrode and the negative electrode can be, for example, carboxymethyl cellulose, methyl cellulose, hydroxymethyl cellulose, ethyl cellulose, polyvinyl alcohol, oxidized starch, phosphated starch, or casein.

The conductive agent for use in the positive electrode and the negative electrode can be, for example, a metal material such as copper (Cu) or nickel (Ni), and a carbon material such as graphite or carbon black.

When the positive electrode mixture contains a conductive agent, the amount of the conductive agent in the positive electrode mixture is preferably 1.2 parts by weight and more and 6.0 parts by weight or less per 100 parts by weight of the positive electrode active material. Also, the conductive agent added to the positive electrode mixture preferably includes at least one selected from the group consisting of graphite and carbon black.

By setting the amount of the conductive agent in the positive electrode mixture in the above range, it is possible to further equalize the degree of polarization of the positive electrode and the degree of polarization of the negative electrode upon repeated charge/discharge. It is therefore possible to further improve the cycle characteristics of the non-aqueous electrolyte secondary battery.

If the amount of the conductive agent is less than 1.2 parts by weight per 100 parts by weight of the positive electrode active material, there is less contact between the positive electrode active material and the conductive agent, so that the internal resistance during charging/discharging becomes high. As a result, the degree of polarization of the positive electrode becomes greater than the degree of polarization of the negative electrode, which may result in degradation of cycle characteristics.

If the amount of the conductive agent exceeds 6.0 parts by weight per 100 parts by weight of the positive electrode active material, there is much contact between the active material and the conductive agent, so that the degree of activity of the positive electrode is enhanced. As a result, the degree of polarization of the positive electrode becomes less than the degree of polarization of the negative electrode, which may result in degradation of the cycle characteristics.

The shape of the graphite may be, for example, flaky or spherical. It is also possible to use particulate graphite. When graphite is used as the conductive agent of the positive electrode, flaky graphite is desirable since it has high conductivity.

Examples of carbon black include acetylene black and ketjen black.

The separator disposed between the positive electrode and the negative electrode is not particularly limited. The separator can be, for example, an organic microporous film or an inorganic microporous film. The organic microporous film can be, for example, a porous sheet or non-woven fabric made by using polyolefin such as polyethylene (PE) or polypropylene (PP) as a raw material. The thickness of the organic microporous film is preferably 10 to 40 μm.

The inorganic microporous film includes, for example, an inorganic filler and an organic binder for binding the inorganic filler. The inorganic filler can be, for example, alumina or silica.

The inorganic microporous film should be interposed between the positive electrode and the negative electrode. Examples of methods of interposing an inorganic microporous film between the positive electrode and the negative electrode include a method of forming an inorganic microporous film on the surface of the positive electrode facing the negative electrode, a method of forming an inorganic microporous film on the surface of the negative electrode facing the positive electrode, and a method of forming an inorganic microporous film on the surfaces of both the positive electrode and the negative electrode. The thickness of the inorganic microporous film is preferably 1 to 20 μm.

The separator may include both an inorganic microporous film and an organic microporous film. In the case of using both an inorganic microporous film and an organic microporous film, the thickness of the inorganic microporous film is preferably 1 to 10 μm. Also, the thickness of the organic microporous film is preferably 10 to 40 μm.

The production method of the non-aqueous electrolyte secondary battery of the present invention is not particularly limited, and an appropriate method can be selected from commonly employed methods.

There is also no particular limitation with respect to the shape of the non-aqueous electrolyte secondary battery of the present invention. For example, the non-aqueous electrolyte secondary battery of the present invention may be a cylindrical battery including a wound electrode group that is obtained by spirally winding sheet electrodes and a separator, or may be a cylindrical battery of the inside-out structure composed of a combination of a pellet electrode and a separator. Alternatively, the non-aqueous electrolyte secondary battery of the present invention may be a coin-type battery composed of a laminate of pellet electrodes and a separator.

### EXAMPLES

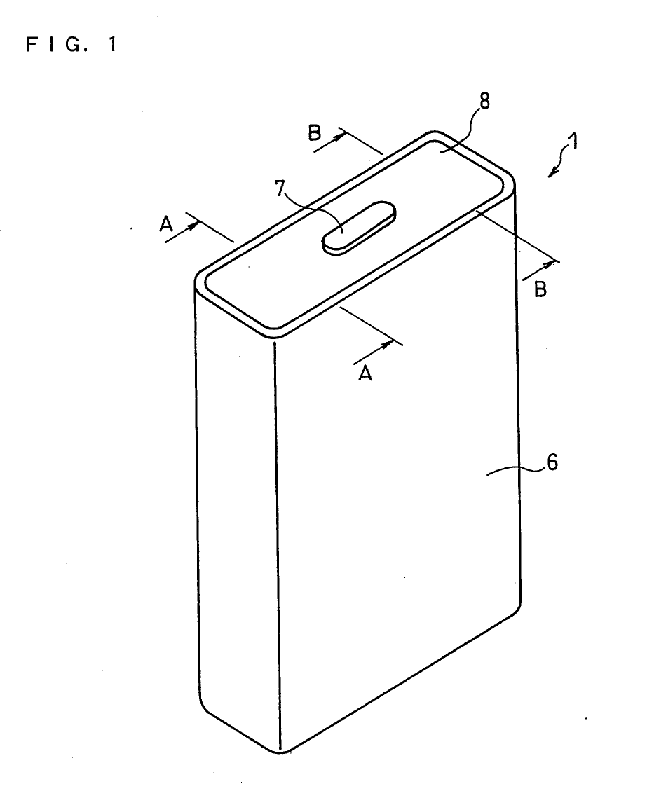

In the following examples, non-aqueous electrolyte secondary batteries illustrated in FIGS. 1 to 3 were produced.

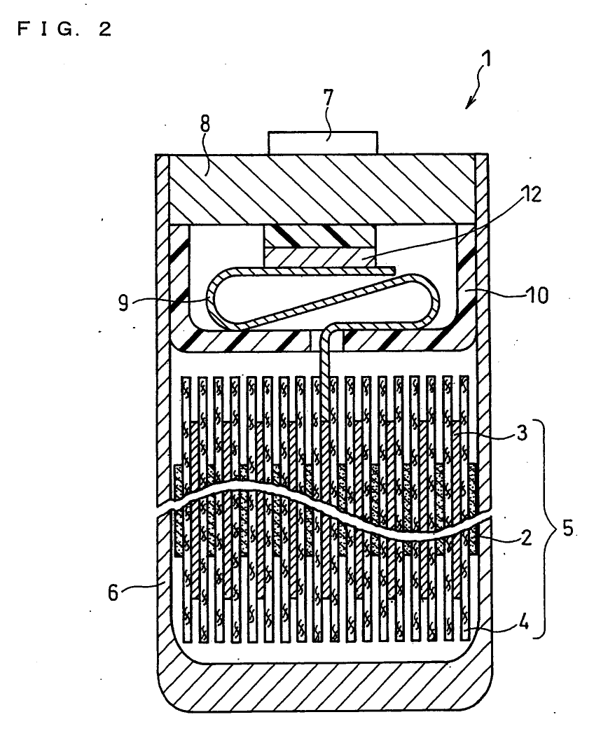

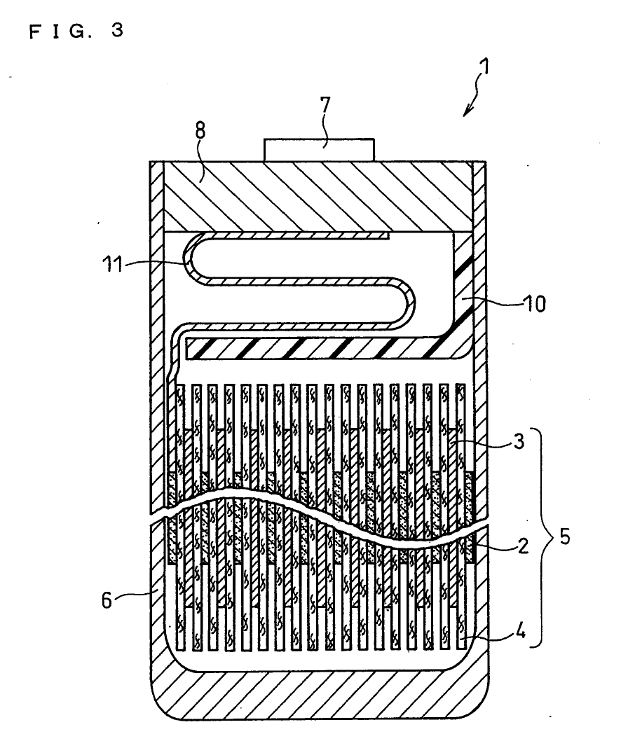

FIG. 1 is a perspective view of a flat rectangular battery 1, FIG. 2 is a cross-sectional view taken along the A-A line of FIG. 1, and FIG. 3 is a cross-sectional view taken along the B-B line of FIG. 1.

In the battery 1, an electrode plate group 5, which includes a positive electrode 2, a negative electrode 3, and a separator 4 interposed between the positive electrode 2 and the negative electrode 3, and a non-aqueous electrolyte (not shown) are housed in a cylindrical battery case 6 with a bottom, as illustrated in FIG. 2 and FIG. 3. The separator 4 used is a 20-μm thick porous film made of polyethylene. The battery case 6 is composed of aluminum (Al). The battery case 6 functions as the positive electrode terminal.

Above the electrode plate group 5 is disposed a resin flame 10.

The opening of the battery case 6 is sealed by laser welding the open edge of the battery case 6 to a sealing plate 8 having a negative electrode terminal 7. The negative electrode terminal 7 is insulated from the sealing plate 8.

One end of a nickel negative electrode lead wire 9 is connected to the negative electrode 3. The other end of the negative electrode lead wire 9 is laser welded to a portion 12 that is electrically connected to the negative electrode terminal 7 and insulated from the sealing plate 8.

As illustrated in FIG. 3, one end of an aluminum positive electrode lead wire 11 is connected to the positive electrode 2. The other end of the positive electrode lead wire 11 is laser welded to the sealing plate 8.

The produced battery was 50 mm long, 34 mm wide, and 5 mm thick in size. The battery capacity was 1100 mAh.

Purified natural graphite surface-treated with pitch was used as the negative electrode active material. The negative electrode active material, a carboxymethyl cellulose thickener, and a styrene-butadiene rubber binder were mixed together in a weight ratio of 100:2:2. The resultant mixture was compounded with the addition of water, to obtain a negative electrode mixture slurry. This slurry was applied onto both sides of a negative electrode current collector (thickness 10 μm) made of copper foil and dried at 200° C. to fully remove the water. The dried electrode plate was rolled by using a roll press and cut into predetermined dimensions to obtain the negative electrode 3.

The positive electrode active material used in the positive electrode and the non-aqueous electrolyte are hereinafter described in detail. The present invention is not to be construed as being limited to the following Examples and appropriate modifications are possible as long as the spirit of the present invention is not changed.

### Example 1

### Battery A1

A positive electrode active material (LiNi_{0.6}Co_{0.3}Al_{0.1}O₂), an acetylene black conductive agent, and a polyvinylidene fluoride binder were mixed together in a weight ratio of 90:5:5. The resultant mixture was compounded with the addition of N-methyl-2-pyrrolidone (NMP), to prepare a positive electrode mixture slurry. In the slurry, the amount of acetylene black was 5.6 parts by weight per 100 parts by weight of the positive electrode active material.

This slurry was applied onto both sides of an aluminum foil current collector (thickness 15 μm) and dried at 120° C. to remove the NMP. The dried electrode plate was rolled by applying a predetermined pressure by means of a roll press and cut into predetermined dimensions to prepare a positive electrode plate. The porosity of the rolled positive electrode mixture was 16% by volume. The porosity of the positive electrode mixture was obtained by the above-described formula:

[(Pore volume)/(Apparent volume of positive electrode mixture)]×100

The measurement of the pore volume was performed at 25° C. by using a porosimeter (POREPLOT-PCW available from Shimadzu Corporation). The height of the positive electrode mixture was obtained by observing a longitudinal section of the positive electrode mixture with an electron microscope, measuring the heights at several locations, and averaging these values.

The positive electrode plate obtained was left in an atmosphere with a dew point of −25° C. for 24 hours, to cause the positive electrode mixture adsorb moisture. In this way, a positive electrode 2 was produced.

A non-aqueous electrolyte A was prepared by dissolving LiPF₆ at a concentration of 1.0 mol/L in a solvent mixture of ethylene carbonate (EC) and ethyl methyl carbonate (EMC) in a volume ratio of 2:8.

Using the positive electrode 2, the negative electrode 3, and the non-aqueous electrolyte A, the above-described battery was produced. This battery was designated as a battery A1.

With the positive electrode 2, the amount of moisture contained in the positive electrode mixture excluding the positive electrode current collector was measured as follows.

The battery produced was preliminarily charged/discharged and then stored at room temperature for 1 month. Thereafter, the stored battery was disassembled to collect the positive electrode. The collected positive electrode was immersed in an ethyl methyl carbonate solution (ethyl methyl carbonate concentration 99.9%) at room temperature for 30 minutes. The immersed positive electrode was dried at room temperature under a reduced pressure (10 Pa) for 30 minutes, to volatilize the ethyl methyl carbonate component.

The dried positive electrode was cut into rectangular slices. All the slices were heated at 300° C., and the amount of moisture contained in the positive electrode mixture was measured by using a Karl Fischer moisture meter (part number CA-100 available from Mitsubishi Chemical Corporation). As a result, the amount of moisture contained in the positive electrode mixture of the battery A1 was 3500 ppm.

It should be noted that there is almost no difference in the amount of moisture measured between the case where the amount of moisture in the positive electrode mixture was measured when the battery was disassembled immediately after battery production and the case where the amount of moisture in the positive electrode mixture was measured after the battery was preliminarily charged/discharged after the production thereof and stored for a long period of time.

### Battery A2

A battery A2 was produced in the same manner as the battery A1, except that the positive electrode plate was left in an atmosphere with a dew point of −25° C. for 0.5 hour to adsorb moisture in preparing a positive electrode. The amount of moisture contained in the positive electrode mixture of the battery A2 was measured in the above manner and turned out to be 1100 ppm.

### Battery A3

A battery A3 was produced in the same manner as the battery A1, except that the positive electrode plate was left in an atmosphere with a dew point of −25° C. for 1.5 hours to adsorb moisture in preparing a positive electrode. The amount of moisture contained in the positive electrode mixture of the battery A3 was measured in the above manner and turned out to be 2000 ppm.

### Battery A4

A battery A4 was produced in the same manner as the battery A1, except that the positive electrode plate was left in an atmosphere with a dew point of −25° C. for 110 hours to adsorb moisture in preparing a positive electrode. The amount of moisture contained in the positive electrode mixture of the battery A4 was measured in the above manner and turned out to be 5000 ppm.

### Battery A5

A battery A5 was produced in the same manner as the battery A1, except that the positive electrode plate was left in an atmosphere with a dew point of −25° C. for 270 hours to adsorb moisture in preparing a positive electrode. The amount of moisture contained in the positive electrode mixture of the battery A5 was measured in the above manner and turned out to be 5900 ppm.

### Battery A6

A non-aqueous electrolyte B was prepared by dissolving LiPF₆ at a concentration of 1.0 mol/L in a solvent mixture of ethylene carbonate (EC), ethyl methyl carbonate (EMC), and diethyl carbonate (DEC) in a volume ratio of 20:65:15. A battery A6 was produced in the same manner as the battery A1 except for the use of the non-aqueous electrolyte B.

### Battery A7

A non-aqueous electrolyte C was prepared by dissolving LiPF₆ at a concentration of 1.0 mol/L in a solvent mixture of EC, EMC, and DEC in a volume ratio of 20:60:20. A battery A7 was produced in the same manner as the battery A1 except for the use of the non-aqueous electrolyte C.

### Battery A8

A non-aqueous electrolyte D was prepared by dissolving LiPF₆ at a concentration of 1.0 mol/L in a solvent mixture of EC, EMC, and DEC in a volume ratio of 20:30:50. A battery A8 was produced in the same manner as the battery A1 except for the use of the non-aqueous electrolyte D.

### Battery A9

A non-aqueous electrolyte E was prepared by dissolving LiPF₆ at a concentration of 1.0 mol/L in a solvent mixture of EC, EMC, and DEC in a volume ratio of 20:20:60. A battery A9 was produced in the same manner as the battery A1 except for the use of the non-aqueous electrolyte E.

### Battery A10

A non-aqueous electrolyte F was prepared by dissolving LiPF₆ at a concentration of 1.0 mol/L in a solvent mixture of EC, EMC, and DEC in a volume ratio of 20:15:65. A battery A10 was produced in the same manner as the battery A1 except for the use of the non-aqueous electrolyte F.

### Battery A11

A non-aqueous electrolyte G was prepared by dissolving LiPF₆ at a concentration of 1.0 mol/L in a solvent mixture of EC and DEC in a volume ratio of 20:80. A battery A11 was produced in the same manner as the battery A1 except for the use of the non-aqueous electrolyte G.

### Battery A12

A battery A12 was produced in the same manner as the battery A1 except for the addition of biphenyl to the non-aqueous electrolyte A. The amount of biphenyl added was 0.3 part by weight per 100 parts by weight of the non-aqueous electrolyte A.

### Battery A13

A battery A13 was produced in the same manner as the battery A12 except that the amount of biphenyl added was 0.8 part by weight per 100 parts by weight of the non-aqueous electrolyte A.

### Battery A14

A battery A14 was produced in the same manner as the battery A12 except that the amount of biphenyl added was 1.2 parts by weight per 100 parts by weight of the non-aqueous electrolyte A.

### Battery A15

A battery A15 was produced in the same manner as the battery A1 except for the addition of cyclohexyl benzene to the non-aqueous electrolyte A. The amount of cyclohexyl benzene added was 0.8 part by weight per 100 parts by weight of the non-aqueous electrolyte A.

### Battery A16

A battery A16 was produced in the same manner as the battery A1 except for the addition of diphenyl ether to the non-aqueous electrolyte A. The amount of diphenyl ether added was 0.8 part by weight per 100 parts by weight of the non-aqueous electrolyte A.

### Battery A17

A battery A17 was produced in the same manner as the battery A1 except for the addition of o-terphenyl to the non-aqueous electrolyte A. The amount of o-terphenyl added was 0.8 part by weight per 100 parts by weight of the non-aqueous electrolyte A.

### Battery A18

A battery A18 was produced in the same manner as the battery A1 except for the addition of p-terphenyl to the non-aqueous electrolyte A. The amount of p-terphenyl added was 0.8 part by weight per 100 parts by weight of the non-aqueous electrolyte A.

### Battery A19

A battery A19 was produced in the same manner as the battery A1 except for the addition of fluoroanisole to the non-aqueous electrolyte A. The amount of fluoroanisole added was 0.8 part by weight per 100 parts by weight of the non-aqueous electrolyte A.

### (Comparative Battery B1)

A comparative battery B1 was produced in the same manner as the battery A1, except that the positive electrode plate was not caused to adsorb moisture. The amount of moisture contained in the positive electrode mixture of the battery B1 was measured in the same manner as described above and turned out to be 900 ppm.

### (Comparative Battery B2)

A comparative battery B2 was produced in the same manner as the battery A1, except that the positive electrode plate was left in an atmosphere with a dew point of −25° C. for 300 hours to adsorb moisture in preparing a positive electrode. The amount of moisture contained in the positive electrode mixture of the battery B2 was measured in the same manner as described above and turned out to be 6100 ppm.

### Battery A20

A battery A20 was produced in the same manner as the battery A12 except that the amount of biphenyl added was 0.2 part by weight per 100 parts by weight of the non-aqueous electrolyte A.

### Battery A21

A battery A21 was produced in the same manner as the battery A12 except that the amount of biphenyl added was 1.3 parts by weight per 100 parts by weight of the non-aqueous electrolyte A.

Table 1 shows the amounts of moisture in the positive electrode mixtures, the non-aqueous solvents, and the kinds and amounts of the organic substances added to the non-aqueous electrolyte, for the batteries A1 to A21 and the comparative batteries B1 to B2.

TABLE 1

| | Amount of | | | |
|---|---|---|---|---|
| | moisture in | | Kind of organic | |
| | positive | | substance added | Amount of organic |
| | electrode | Non-aqueous | to non-aqueous | substance added |
| | mixture (ppm) | solvent | electrolyte | (part by weight) |
| Battery A1 | 3500 | EC:EMC = 20:80 | — | — |
| Battery A2 | 1100 | EC:EMC = 20:80 | — | — |
| Battery A3 | 2000 | EC:EMC = 20:80 | — | — |
| Battery A4 | 5000 | EC:EMC = 20:80 | — | — |
| Battery A5 | 5900 | EC:EMC = 20:80 | — | — |
| Battery A6 | 3500 | EC:EMC:DEC = 20:65:15 | — | — |
| Battery A7 | 3500 | EC:EMC:DEC = 20:60:20 | — | — |
| Battery A8 | 3500 | EC:EMC:DEC = 20:30:50 | — | — |
| Battery A9 | 3500 | EC:EMC:DEC = 20:20:60 | — | — |
| Battery A10 | 3500 | EC:EMC:DEC = 20:15:65 | — | — |
| Battery A11 | 3500 | EC:DEC = 20:80 | — | — |
| Battery A12 | 3500 | EC:EMC = 20:80 | BP | 0.30 |
| Battery A13 | 3500 | EC:EMC = 20:80 | BP | 0.80 |
| Battery A14 | 3500 | EC:EMC = 20:80 | BP | 1.20 |
| Battery A15 | 3500 | EC:EMC = 20:80 | CHB | 0.80 |
| Battery A16 | 3500 | EC:EMC = 20:80 | DPE | 0.80 |
| Battery A17 | 3500 | EC:EMC = 20:80 | OTP | 0.80 |
| Battery A18 | 3500 | EC:EMC = 20:80 | PTP | 0.80 |
| Battery A19 | 3500 | EC:EMC = 20:80 | FA | 0.80 |
| Comp. battery | 900 | EC:EMC = 20:80 | — | — |
| B1 | | | | |
| Comp. battery | 6100 | EC:EMC = 20:80 | — | — |
| B2 | | | | |
| Battery A20 | 3500 | EC:EMC = 20:80 | BP | 0.20 |
| Battery A21 | 3500 | EC:EMC = 20:80 | BP | 1.30 |

BP: biphenyl, CHB: cyclohexyl benzene, DPE: diphenyl ether, OTP: o-terphenyl, PTP: p-terphenyl, FA: fluoroanisole

The batteries A1 to A21 and comparative batteries B1 to B2 were evaluated as follows.

### [Evaluation]

### (Cycle Characteristics)

In a constant-temperature atmosphere at 25° C. and 45° C., the respective batteries were charged at a current of an hour-rate 1.0 It amperes until the battery voltage reached 4.2 V. The charged batteries were discharged at a current of an hour-rate 1.0 It amperes until the battery voltage dropped to 2.5 V. Such charge/discharge cycle was repeated 500 times.

The ratio of the discharge capacity at the 500^{th} cycle to the discharge capacity at the 1^{st} cycle was defined as capacity retention rate. Table 2 shows the results. In Table 2, the capacity retention rate is expressed as a percentage.

(Battery Thickness after Charge/Discharge Cycles)

The thickness of each battery immediately after battery production (initial thickness) and the thickness of the central part of each battery subjected to the above-mentioned charge/discharge cycle 500 times in a constant-temperature atmosphere at 25° C. and 45° C. (battery thickness) were measured with a linear gauge. The ratio of the thickness of each battery after charge/discharge to the initial thickness of each battery (battery thickness ratio) was obtained. Table shows the results. In Table 2, the ratio is expressed as a percentage.

TABLE 2

| | Capacity | Battery | Capacity | Battery |
|---|---|---|---|---|
| | retention | thickness | retention | thickness |
| | rate at 25° C. | ratio at 25° C. | rate at 45° C. | ratio at 45° C. |
| | (%) | (%) | (%) | (%) |
| Battery A1 | 87 | 110 | 78 | 117 |
| Battery A2 | 86 | 110 | 78 | 115 |
| Battery A3 | 87 | 110 | 78 | 116 |
| Battery A4 | 88 | 111 | 78 | 118 |
| Battery A5 | 88 | 111 | 78 | 119 |
| Battery A6 | 88 | 110 | 79 | 115 |
| Battery A7 | 89 | 109 | 80 | 114 |
| Battery A8 | 89 | 107 | 81 | 111 |
| Battery A9 | 90 | 106 | 82 | 110 |
| Battery A10 | 90 | 106 | 82 | 110 |
| Battery A11 | 90 | 105 | 82 | 109 |
| Battery A12 | 89 | 111 | 79 | 116 |
| Battery A13 | 90 | 111 | 80 | 116 |
| Battery A14 | 89 | 112 | 79 | 116 |
| Battery A15 | 90 | 110 | 81 | 115 |
| Battery A16 | 90 | 112 | 80 | 115 |
| Battery A17 | 89 | 113 | 78 | 118 |
| Battery A18 | 89 | 113 | 79 | 117 |
| Battery A19 | 89 | 112 | 80 | 116 |
| Comp. battery B1 | 80 | 125 | 80 | 115 |
| Comp. battery B2 | 87 | 120 | 82 | 125 |
| Battery A20 | 87 | 111 | 78 | 117 |
| Battery A21 | 84 | 117 | 73 | 119 |

The results of Table 2 indicate that the batteries A1 to A5 have better cycle characteristics at 25° C. than the comparative battery B1. Controlling the amount of moisture contained in the positive electrode mixture can increase the initial polarization of the positive electrode. This permits an improvement in the balance between the degree of polarization of the positive electrode and the degree of polarization of the negative electrode after repetitive charge/discharge. This is probably the reason why the cycle characteristics were improved.

Also, it can be understood that the battery thickness ratios at 25° C. and 45° C. for the batteries A1 to A5 are less than those for the comparative battery B2.

The results of the batteries A1 to A5 show that as the amount of moisture contained in the positive electrode mixture increases, the battery thickness ratio at 45° C. increases. When the amount of moisture contained in the positive electrode mixture is large, the surplus lithium compound remaining in the positive electrode active material adsorbs carbon dioxide in the atmosphere, for example, after the preparation of the positive electrode. When a battery made with such a positive electrode is repeatedly charged/discharged, carbon dioxide is produced in the battery. This is probably the reason why the battery thickness increased after the charge/discharge cycles.

The results of the batteries A1 and A6 to A11 show that increasing the ratio of diethyl carbonate in the non-aqueous solvent suppresses the evolution of gas due to charge/discharge cycles, heightens the capacity retention rate after 500 cycles, and reduces the battery thickness. This is probably because diethyl carbonate is resistant to decomposition during charging/discharging and the increased ratio of diethyl carbonate enabled a reduction in the amount of gas generated by repetitive charge/discharge.

The batteries A12, A13, and A14 exhibited better cycle characteristics at 25° C. and 45° C. than the batteries A20 to A21. This is probably because the non-aqueous electrolyte included an organic substance containing at least one selected from the group consisting of a benzene ring and a cyclohexane ring in an appropriate amount, thereby improving the balance between the degree of polarization of the positive electrode and the degree of polarization of the negative electrode.

The cycle characteristics of the battery A20 at 25° C. and 45° C. and the battery thickness after charge/discharge cycles were almost equivalent to those for the battery A1. It can thus be presumed that the effect of further enhancing the polarization of the positive electrode is slightly insufficient in the comparative battery A20 in which the amount of the organic substance added is small.

The battery A21 exhibited slightly low cycle characteristics at 45° C., and this is probably because during the charge/discharge cycles at 45° C., the excessive amount of biphenyl slightly increased the polarization of the positive electrode.

The results of the batteries A15 to A19 indicate that the addition of the organic substance other than biphenyl to the non-aqueous electrolyte results in similar cycle characteristics and battery thickness ratio to those for the battery A13.

A comparison of the battery thickness ratio of the comparative battery B1 and the battery thickness ratio of the comparative battery B2 at 25° C. shows that the battery thickness ratio of the comparative battery B1 with a smaller moisture content is higher. The capacity retention rate of the comparative battery B1 at 25° C. was a value lower than those of the other batteries. It is thus presumed that upon repeated charge/discharge cycles, gas was generated by the decomposition of the non-aqueous electrolyte and the like, thereby resulted in the higher battery thickness ratio of the comparative battery B1.

### Example 2

### Battery A22

A battery A22 was produced in the same manner as the battery A1, except that the porosity of the positive electrode mixture was set to 12% by volume by adjusting the pressure applied for rolling.

### Battery A23

A battery A23 was produced in the same manner as the battery A1, except that the porosity of the positive electrode mixture was set to 21% by volume by adjusting the pressure applied for rolling.

### Battery A24

A battery A24 was produced in the same manner as the battery A1, except that the porosity of the positive electrode mixture was set to 10% by volume by adjusting the pressure applied for rolling.

### Battery A25

A battery A25 was produced in the same manner as the battery A1, except that the porosity of the positive electrode mixture was set to 23% by volume by adjusting the pressure applied for rolling.

The cycle characteristics and battery thickness ratio of the batteries A22 to A25 were measured in the same manner as in Example 1. Table 3 shows the results. Table 3 also shows the results of the battery A1. In addition, Table 3 shows the amounts of moisture contained in the positive electrode mixtures and the porosities thereof for the batteries A22 to A25.

TABLE 3

| | Amount of | Porosity | | | | |
|---|---|---|---|---|---|---|
| | moisture | of | | Battery | | Battery |
| | in | positive | Capacity | thick- | Capacity | thick- |
| | positive | elec- | retention | ness | retention | ness |
| | electrode | trode | rate at | ratio at | rate at | ratio at |
| | mixture | mixture | 25° C. | 25° C. | 45° C. | 45° C. |
| | (ppm) | (%) | (%) | (%) | (%) | (%) |
| Battery | 3500 | 16 | 87 | 110 | 78 | 117 |
| A1 | | | | | | |
| Battery | 3500 | 12 | 86 | 111 | 78 | 116 |
| A22 | | | | | | |
| Battery | 3500 | 21 | 86 | 109 | 78 | 115 |
| A23 | | | | | | |
| Battery | 3500 | 10 | 67 | 116 | 74 | 118 |
| A24 | | | | | | |
| Battery | 3500 | 23 | 61 | 117 | 73 | 119 |
| A25 | | | | | | |

The results of Table 3 indicate that the battery A1 and the batteries A22 to A23 have better cycle characteristics at 25° C. and 45° C. than the batteries A24 to A25. This is probably because controlling the porosity of the positive electrode mixture improves the balance between the degree of polarization of the positive electrode and the degree of polarization of the negative electrode.

The cycle characteristics of the battery A24 lowered slightly probably for the following reason. In the battery A24, the porosity of the positive electrode mixture was reduced. As a result, the volume ratio of the non-aqueous electrolyte in the positive electrode mixture became low, thereby resulting in an increase in internal resistance during charging/discharging. Thus, the degree of polarization of the positive electrode became greater than the degree of polarization of the negative electrode. This is probably the reason why the cycle characteristics lowered slightly.

The cycle characteristics of the battery A25 lowered slightly probably for the following reason. In the battery A25, the porosity of the positive electrode mixture was increased. As a result, the degree of activity of the positive electrode was enhanced, and the degree of polarization of the positive electrode became less than the degree of polarization of the negative electrode. This is probably the reason why the cycle characteristics lowered slightly.

### Example 3

### Battery A26

A battery A26 was produced in the same manner as the battery A1, except that the positive electrode active material (LiNi_{0.6}Co_{0.3}Al_{0.1}O₂), acetylene black, and polyvinylidene fluoride were mixed in a weight ratio of 93.9:1.1:5 in preparing a positive electrode. In the battery A26, the amount of conductive agent (acetylene black) was 1.2 parts by weight per 100 parts by weight of the positive electrode active material.

### Battery A27

A battery A27 was produced in the same manner as the battery A1, except that the positive electrode active material (LiNi_{0.6}Co_{0.3}Al_{0.1}O₂), acetylene black, and polyvinylidene fluoride were mixed in a weight ratio of 89.6:5.4:5 in preparing a positive electrode. In the battery A27, the amount of acetylene black was 6.0 parts by weight per 100 parts by weight of the positive electrode active material.

### Battery A28

A battery A28 was produced in the same manner as the battery A26, except for the use of ketjen black in place of acetylene black. In the battery A28, the amount of Ketjen black was 1.2 parts by weight per 100 parts by weight of the positive electrode active material.

### Battery A29

A battery A29 was produced in the same manner as the battery A27, except for the use of ketjen black in place of acetylene black. In the battery A29, the amount of Ketjen black was 6.0 parts by weight per 100 parts by weight of the positive electrode active material.

### Battery A30

A battery A30 was produced in the same manner as the battery A26, except for the use of graphite in place of acetylene black. In the battery A30, the amount of graphite was 1.2 parts by weight per 100 parts by weight of the positive electrode active material.

### Battery A31

A battery A31 was produced in the same manner as the battery A27, except for the use of graphite in place of acetylene black. In the battery A31, the amount of graphite was 6.0 parts by weight per 100 parts by weight of the positive electrode active material.

### Battery A32

A battery A32 was produced in the same manner as the battery A1, except that the positive electrode active material (LiNi_{0.6}Co_{0.3}Al_{0.1}O₂), acetylene black, and polyvinylidene fluoride were mixed in a weight ratio of 94:1:5 in preparing a positive electrode. In the battery A32, the amount of acetylene black was 1.1 parts by weight per 100 parts by weight of the positive electrode active material.

### Battery A33

A battery A33 was produced in the same manner as the battery A1, except that the positive electrode active material (LiNi_{0.6}Co_{0.3}Al_{0.1}O₂), acetylene black, and polyvinylidene fluoride were mixed in a weight ratio of 89.2:5.8:5 in preparing a positive electrode. In the battery A33, the amount of acetylene black was 6.5 parts by weight per 100 parts by weight of the positive electrode active material.

The cycle characteristics and battery thickness ratio of the batteries A26 to A33 were measured in the same manner as in Example 1. Table 4 shows the results. Table 4 also shows the results of the battery A1. In addition, Table 4 shows the kinds and amounts of the conductive agents contained in the positive electrode mixtures of the batteries to A33, and the amounts of moisture contained in the positive electrode mixtures thereof.

TABLE 4

| | Amount of | | | | | | |
|---|---|---|---|---|---|---|---|
| | moisture | | | | | | |
| | in | | Amount of | Capacity | Battery | Capacity | Battery |
| | positive | | conductive | retention | thickness | retention | thickness |
| | electrode | Kind of | agent | rate at | ratio at | rate at | ratio at |
| | mixture | conductive | (part by | 25° C. | 25° C. | 45° C. | 45° C. |
| | (ppm) | agent | weight) | (%) | (%) | (%) | (%) |
| Battery | 3500 | AB | 5.6 | 87 | 110 | 78 | 117 |
| A1 | | | | | | | |
| Battery | 3500 | AB | 1.2 | 86 | 111 | 77 | 116 |
| A26 | | | | | | | |
| Battery | 3500 | AB | 6.0 | 86 | 109 | 80 | 114 |
| A27 | | | | | | | |
| Battery | 3500 | KB | 1.2 | 89 | 111 | 78 | 116 |
| A28 | | | | | | | |
| Battery | 3500 | KB | 6.0 | 87 | 109 | 80 | 115 |
| A29 | | | | | | | |
| Battery | 3500 | GR | 1.2 | 88 | 111 | 79 | 117 |
| A30 | | | | | | | |
| Battery | 3500 | GR | 6.0 | 86 | 109 | 81 | 113 |
| A31 | | | | | | | |
| Battery | 3500 | AB | 1.1 | 69 | 115 | 73 | 118 |
| A32 | | | | | | | |
| Battery | 3500 | AB | 6.5 | 58 | 119 | 76 | 119 |
| A33 | | | | | | | |

AB: acetylene black
KB: ketjen black
GR: graphite

The results of Table 4 show that the battery A1 and the batteries A26 to A27 had better cycle characteristics at 25° C. and 45° C. than the batteries A32 to A33. This is probably because controlling the amount of conductive agent contained in the positive electrode mixture improved the balance between the degree of polarization of the positive electrode and the degree of polarization of the negative electrode.

The battery A32 exhibited slightly low cycle characteristics compared with the other batteries. This is probably for the following reason. Since the amount of conductive agent contained in the positive electrode mixture of the battery A32 is small, there is less contact between the positive electrode active material and the conductive agent. Thus, the internal resistance during charging/discharging becomes high and the degree of polarization of the positive electrode becomes greater than the degree of polarization of the negative electrode. This is probably the reason why the cycle characteristics were slightly low.

The battery A33 exhibited slightly low cycle characteristics compared with the other batteries. This is probably for the following reason. Since the amount of conductive agent contained in the positive electrode mixture of the battery A33 is large, the degree of activity of the positive electrode is enhanced, so that the degree of polarization of the positive electrode becomes less than the degree of polarization of the negative electrode. This is probably the reason why the cycle characteristics were slightly low.

The results of the batteries A28 to A31 indicate that when the amount of conductive agent is in the range of 1.2 to 6.0 parts by weight per 100 parts by weight of the positive electrode active material, excellent cycle characteristics can be obtained even if ketjen black or graphite is used in place of acetylene black.

### INDUSTRIAL APPLICABILITY

The non-aqueous electrolyte secondary battery of the present invention can be used, for example, as the main power source for electronic devices, etc. The non-aqueous electrolyte secondary battery of the present invention is suited for applications, for example, as the main power source for commercial mobile tools such as cellular phones and notebook personal computers, the main power source for power tools such as electric screwdrivers, and the main power source for industrial machinery such as electric vehicles (EV).

1. A non-aqueous electrolyte secondary battery comprising a positive electrode comprising a positive electrode mixture, a negative electrode, a separator, and a non-aqueous electrolyte,
wherein said positive electrode mixture includes a positive electrode active material, said positive electrode active material comprising a lithium nickel composite oxide,
said non-aqueous electrolyte comprises a non-aqueous solvent and a lithium salt dissolved in said non-aqueous solvent, and
the amount of moisture contained in said positive electrode mixture is greater than 1000 ppm and equal to or less than 6000 ppm.

2. The non-aqueous electrolyte secondary battery in accordance with claim 1, wherein said non-aqueous solvent includes a cyclic carbonate and a chain carbonate.

3. The non-aqueous electrolyte secondary battery in accordance with claim 1, wherein said lithium nickel composite oxide is represented by the following general formula (1):
LiₓNi_{y}M_{1-y}O₂ (1)
where M is at least one element selected from the group consisting of Co, Mn, Cr, Fe, Mg, Ti, and Al, 0.95≦x≦1.10, and 0.3≦y≦1.0.

4. The non-aqueous electrolyte secondary battery in accordance with claim 2, wherein said cyclic carbonate includes at least one selected from the group consisting of ethylene carbonate, propylene carbonate, and butylene carbonate.

5. The non-aqueous electrolyte secondary battery in accordance with claim 2, wherein said chain carbonate includes at least one selected from the group consisting of dimethyl carbonate, diethyl carbonate, ethyl methyl carbonate, di-n-propyl carbonate, methyl-n-propyl carbonate, ethyl-n-propyl carbonate, methyl-i-propyl carbonate, and ethyl-i-propyl carbonate.

6. The non-aqueous electrolyte secondary battery in accordance with claim 5, wherein said chain carbonate is diethyl carbonate alone or includes diethyl carbonate and ethyl methyl carbonate.

7. The non-aqueous electrolyte secondary battery in accordance with claim 6, wherein the volume ratio of diethyl carbonate to ethyl methyl carbonate is from 1:3 to 3:1.

8. The non-aqueous electrolyte secondary battery in accordance with claim 1, wherein said non-aqueous electrolyte further includes an organic substance including at least one selected from the group consisting of a benzene ring and a cyclohexane ring, and the amount of said organic substance is 0.3 to 1.2 parts by weight per 100 parts by weight of the non-aqueous electrolyte.

9. The non-aqueous electrolyte secondary battery in accordance with claim 8, wherein said organic substance includes at least one selected from the group consisting of biphenyl, cyclohexyl benzene, diphenyl ether, o-terphenyl, p-terphenyl, and fluoroanisole.

10. The non-aqueous electrolyte secondary battery in accordance with claim 1, wherein said positive electrode mixture has a porosity of 12 to 21% by volume.

11. The non-aqueous electrolyte secondary battery in accordance with claim 1, wherein said positive electrode mixture includes a conductive agent, and the amount of said conductive agent contained in said positive electrode mixture is 1.2 to 6.0 parts by weight per 100 parts by weight of said positive electrode active material.

12. The non-aqueous electrolyte secondary battery in accordance with claim 11, wherein said conductive agent includes at least one selected from the group consisting of graphite and carbon black.
